(19) United States
(12) Patent Application Publication
(10) Pub. No.: US 2010/0065227 A1
(43) Pub. Date: Mar. 18, 2010

(54) WINDOW BLIND APPARATUSES, SYSTEMS AND/OR METHODS

(75) Inventor: Mary B. Murphy, Denver, CO (US)

Correspondence Address: BERENBAUM WEINSHIENK PC, 370 17TH STREET, SUITE 4800, DENVER, CO, 80202, US

(73) Assignee: NO STRINGS ATTACHED LLC, Denver, CO (US)

(21) Appl. No.: 12/210,938

(22) Filed: Sep. 15, 2008

(51) Int. Cl. E06B 9/30

(52) U.S. Cl. 160/172 R; 160/405

(57) ABSTRACT

A window blind apparatus having a first magnetically active track, a second magnetically active track, a first rod, a second rod, a first magnet located at the first end of the first rod, and a second magnet located at the second end of the first rod, a third magnet located at the first end of the second rod, a fourth magnet located at the second end of the second rod, and a window covering material adapted to be disposed between the first rod and the second rod, wherein the apparatus is adapted to be used to wholly or partially cover the window over which it is mounted.

### BACKGROUND

The present developments are directed generally to window blind apparatuses, but more particularly to a magnetic cordless blind apparatus of a type that may typically be used for residential and commercial window coverings.

A window blind apparatus generally consists of instrumentalities to screen a window, with generally similar results to those obtained by fitting curtains. Blind apparatuses may be the same width and height as the window itself or they may be slightly wider, taller, or smaller depending on whether they are fixed inside or outside the window's reveal (i.e. the wall recess within which the window itself is fixed).

Window blind apparatuses may be used for various purposes. They can have the effect of blocking unwanted heat, light of the sun, unwanted viewing from those outside the window or they can have insulative effects in cold weather. They may also reduce or mitigate light to varying degrees, depending on the design. Many kinds of blind apparatuses strive to provide the user with varying balances of privacy and shade. Blind apparatuses may be constructed of a number of different materials and manufactured in a number of different ways. They may be adjustable in a variety of ways to effect the foregoing.

Currently, the market for adjustable window blind apparatuses that can be positioned relative to the window generally includes “top-down, bottom-up” blind apparatuses. Such blind apparatuses generally must be purchased in conjunction with installation services, putting an additional premium on the price. Additionally, of the companies that manufacture cellular blind apparatuses, a few manufacture top-down, bottom-up shades which utilize a cord mechanism to lower and raise the blind apparatuses. This cord mechanism can wear out and/or break.

Other manufacturers market a so-called “cordless lift control,” “cordless top-down/bottom-up lift control” or “cordless system” but none of those presently-marketed blinds are truly free of cords. Instead, such blinds generally use a headrail at the top of the window to which cords are attached to raise or lower the blind. Additionally many of the so-called “cordless lift system” features can only be found on top-down blinds.

Improvements and/or alternatives may be available in window blind technologies.

### SUMMARY

The present disclosure relates to a window blind apparatus, system, or method by which the window blind may be used. Namely, the developments hereof concern combinations of one or more adjustable magnetically active tracks, a window covering element, a rod or rods, magnets, optionally a handle or handles, and optionally a blind holder piece to keep the lower portion of the blind in place.

The present developments may provide privacy and shade from sunlight, while allowing enhanced functionality due to a cordless feature. A subject blind can be positioned at the top of the window to block sunlight and still allow the user to see outside through the lower portion of the window. It can be positioned at or about the lower half of the window to allow the user to block out the ability of people who are walking by, standing outside or across the street from seeing in while allowing the user to see out through the window over the top of the blind. It can even be positioned in or about the middle of the user's window if the user so chooses.

The present developments may provide adjustability, in that the blinds can be placed in virtually any portion of the window, or fully extended to cover the entire window. To change the blind position the user may move them down from the top of the window or up from the bottom. The movement may be guided by channels in the magnetically active tracks. The window covering element may be mounted on the rod or rods and the rods may be inserted into a tracks and pulled up and down along the track by the user.

### BRIEF DESCRIPTION OF THE DRAWINGS

In the drawings:

FIG. 1 provides a front elevational view of a blind apparatus hereof;

FIG. 2 provides a perspective view of a partially assembled blind apparatus hereof;

FIG. 3 provides another front elevational view of the blind apparatus as assembled; and,

FIG. 4 provides a perspective view of the magnet and track interface.

### DETAILED DESCRIPTION

The developments hereof relate to a blind apparatus, system and/or method, such typically being adapted to enable one or more of easy installation, assembly, and use, and a system and method of use thereof. In many implementations, the blind apparatus has first and second track elements that are adapted to be mounted in parallel alongside a window or similar architectural feature. The track elements may be adapted to receive one or more magnets. The track elements may have a ‘c’ shape defining a channel running longitudinally along the respective track. Typically, the magnets may be mounted on the end of a rod. The apparatus may include one or more rods, which are disposed to be mounted, with the aid of magnets, such that the respective ends thereof are within the track channels and the rods themselves are thus in a generally perpendicular orientation to the track or tracks. Such a rod may in some instances be a typically dimensioned rod for use in window blind applications. In some implementations, the rod and/or tracks may be extendable and/or retractable. The blind apparatus may typically also include a window covering element of a suitable material such as cloth, paper, or a synthetic, adapted to be coupled with the rod or rods.

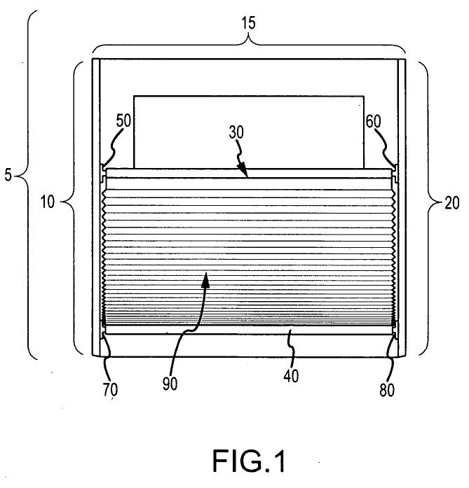

As generally shown in FIG. 1, an implementation of a blind apparatus 5, as such may typically be used to cover a window 15 in many ordinary residential or commercial environments, may have a first track element 10 and a second track element 20. As shown here, the first track element 10 and second track elements 20 may and be adapted to be mounted on a first vertical portion and the corresponding second vertical portion of the perimeter of the window 15, respectively. The position of the track elements may be on the interior of the window reveal, as generally shown in FIG. 1, or the position may be any suitable position within or outside of the window reveal that would allow for the movement described herein. The first track element 10 and the second track element 20 may be of any suitable length to accommodate the dimensions of the window 15. The first track element 10 and the second track element may be of a fixed length, or they may be pre-scored to allow for selection of a fixed length, or they may be adjustable, for example, telescoping, for ease of adjustment of their respective lengths.

The rod or rods, herein shown as a first rod element 30 and a second rod element 40, may be disposed between the first track element 10 and second track element 20. The first rod element 30 and the second rod element 40 may be adjustable to allow them to be adjusted to be disposed between the first track element 10 and the second track element. The rod elements 30 and 40 may be of any suitable dimension to accommodate the dimensions of the window 15 and the first and second track elements 10 and 20. The first rod element 30 may have a first magnet 50 at the interface between first rod element 30 and first track element 10, and a second magnet 60 at the interface between first rod element 30 and second track element 20. The second rod element 40 may have third magnet 70 at the interface between second rod element 40 and first track element 10, and fourth magnet 80, at the interface between second rod element 40 and second track element 20. The window covering element 90 may be disposed between the first rod element 30 and second rod element 40. The window covering element 90 may be fixedly mounted to each of the first rod element 30 and second rod element 40, in such a manner that the window covering element 90 may movably follow the motion of first rod element 30 and second rod element 40 as they move along the first track element 10 and second track element 20.

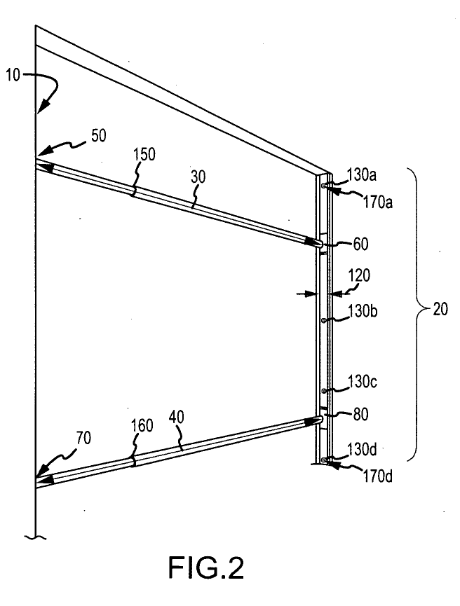

FIG. 2 depicts portions of the blind assembly, shown without any window covering element 90. The first rod element 30 and the second rod element 40 are shown in position between the first track element 10 and the second track element 20. The rod element 30 and the rod element 40 may be extendable, as indicated by the telescoping interface 150 on rod element 30 and the telescoping interface 160 on rod element 40. First magnet element 50 of first rod element 30 is depicted in position at the interface between first rod element 30 and first track element 10. Second magnet element 60 of first rod element 30 is depicted in position at the interface between first rod element 30 and second track element 20. Third magnet element 70 of second rod element 40 is depicted in position at the interface between second rod element 40 and first track element 10. Fourth magnet element 80 of second rod element 40 is depicted in position at the interface between second rod element 40 and second track element 20.

Also in FIG. 2, the second track element 20 is depicted as having a channel 120 along the length of the second track element 20. Second magnet element 60 and fourth magnet element 80 are intended to be of a suitable dimension so as to be disposed within channel 120, and channel 120 is intended to be of a suitable width to accept second magnet element 60 and fourth magnet element 80. Although not shown in detail in FIG. 2, first track element 10 may also have a similarly positioned channel of a suitable dimension to receive first magnet element 50 and third magnet element 70. Depicted within channel 120 are apertures 130a, 130b, 130c, and 130d. In this figure, aperture 130a serves as a mounting point for the second rod element 20, as illustrated by the screw 170a. Similarly, aperture 130d serves as another mounting point for the second track element 20, as illustrated by the screw 170d. Alternatively, the track elements may be mounted to the wall with, for example, any other suitable fixing element, such as a nail, or with an alternative means such as adhesive backing, which may not require a fixing element such as screws or nails. Although the embodiment described herein includes use of magnetically active track elements, magnets at the endpoints of the respective rod elements, and screws for mounting the magnetically active tracks to the wall, alternative embodiments for movement and suspension of the rod elements between the track elements are also contemplated. For example, the track elements may be notched, and the rod elements may be constructed so as to exert pressure against the track elements, allowing for suspension of the rod elements along the track elements at the notched points. Alternatively, another embodiment may employ use of track elements with adhesive properties, constructed to accept rod elements that may or may not be fitted with adhesive endpieces.

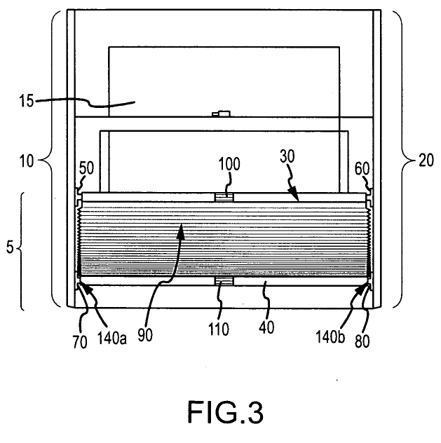

FIG. 3 illustrates the blind apparatus 5 in use; particularly here being used to partially cover a window 15; this as opposed to the view in FIG. 1 wherein the blind apparatus is in use covering a much larger portion of the window. As illustrated in FIG. 3 and FIG. 1, the blind apparatus 5 may be used in such a manner as to achieve partial extension of the window covering material and thereby partially cover the window. The blind apparatus 5 may also be used in such a manner as to achieve full extension of the window covering material.

The first rod element 30 and the second rod element 40 are shown operationally disposed engaged with each of and between the first track element 10 and the second track element 20. The blind 90 is shown here, suspended from the first rod element 30 and connected to the second rod element 40. Here, the first magnet element 50 and the second magnet element 60 of the first rod element 30 serve to suspend the first rod element at an intervening point along the first track element 10 and second track element 20, i.e., first magnet element 50 of first rod element 30 is at approximately an intervening point of the first track element 10, and second magnet element 60 of first rod element 30 is at approximately a corresponding intervening point of the second track element 20. As in FIG. 1, the second rod element 40 is operationally disposed in this usage at or near the respective lower ends of the two track elements 10 and 20, i.e., third magnet element 70 of second rod element 40 is at or near the lower end of the first track element 10, and fourth magnet element 80 of second rod element 40 is at or near the lower end of the second track element 20. Also shown in FIG. 3 are a first handle 100 disposed at an accessible point along the length of the first rod element 30, and a second handle 110 disposed at a similarly accessible point along the length of the second rod element 40; here each near the midpoints of the respective rod elements 30 and 40. The handles 100 and 110 may be used to adjust the position of the respective rod elements upward or downward along the first and second track elements 10 and 20.

Finally, FIG. 3 depicts blind holders 140a and 140b, located respectively at the first end and the second end of the second rod 40. The blind holders 140a and 140b may be clipped into the rod 40 and hold the bottom of the window covering 10 in place.

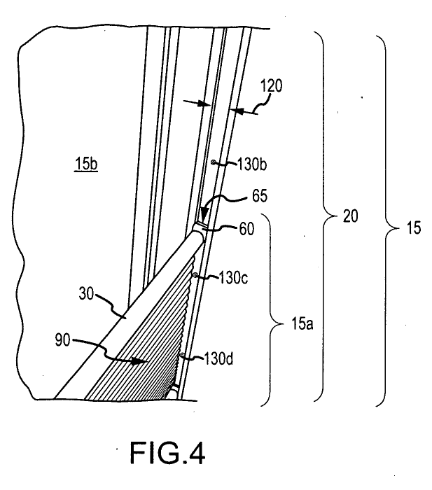

FIG. 4 illustrates an operative position of a magnet within a track element, using as an illustration the second magnet 60 of first rod element 30 as disposed within second track element 20. As shown in FIG. 4, the first rod element 30 is positioned at a point along the second track element 20, with the second magnet element 60 of the first rod element 30 at the interface between first rod element 30 and second track element 20. Second magnet element 60 is shown fitting within the channel 120 defined within the second track element 20. A first side of the magnet, in this case magnet 60, may be attached to the rod 30. A second side of the magnet 60 may interface with the track 20. The magnet 60 may be covered on the second side with a material 65 for the purpose of aiding the rod to glide in the track. The magnet may also be in the form of an endcap or other alternative structure to place over the end of the rod. Window covering element 90 is shown as suspended from first rod element 30 and extends downward from first rod element 30 to cover a first portion 15a of the window 15, leaving another, second portion 15b of the window 15 uncovered.

Also illustrated are apertures 130b, 130c and 130d, along the length of the second rod element 20. The size and location of the apertures 130b, 130c and 130d (and 130a, not depicted in this FIG. 4), may be of any suitable dimension and placement, and may be matched by the corresponding apertures on the first track element 10 (also not depicted in this FIG. 4). Apertures 130a, 130b, 130c, and 130d may be pre-formed into and thus be a part of the second track element 20. There may be more or fewer than the four apertures 130a, 130b, 130c, and 130d illustrated in FIG. 2, depending on the length of the particular track element. The first track element 10 and the second track element 20 may be of a conventional dimension or they may be pre-scored or adjustable for ease of adjustment of their respective lengths.

An apparatus such as any of the blind apparatuses as described herein may thus provide convenient and easily assemblable ways to cover alternatively all or portions of a window. The ease and/or quickness of assembly and the ready availability of the materials to be used for a blind apparatus hereof can be attractive features for an individual attempting to install their own blinds. Thus, it would not be necessary to contract with or employ professional blind installers, at substantial expense and inconvenience. A standard kit or custom order for a personalized kit containing all the parts needed for the user to assemble the blind apparatus may be provided for the user to construct the apparatus. Then, easy assembly as described above may be achieved, i.e. drilling the screws through the apertures for mounting of the track elements to a wall, or nailing the track to the wall, or using alternative mounting such as adhesive or the like, and assembling the remaining parts of the blind apparatus. Markets for use hereof may include places where blinds are frequently used to cover windows, such as homes, businesses, or similar venues.

As introduced above, a variety of alternative structures may be used in the implementation of the developments hereof. Structures described herein may come in different forms. Thus, for example, the structural element which may provide the connective functionality between the tracks may be other than a rod, and may be specially formed to be adapted to the overall blind apparatus. Window covering elements may be structures other than those specified herein. Moreover, though structures have been shown and described in some detail herein, the scope and content hereof is not so limited, and instead may include alternative structures. Still furthermore, the mechanisms hereof are illustrative only as well and not limitative of the scope and content hereof. Other mechanisms may be used to the same or substantially the same effect, and thus be covered hereby.

Apparatuses hereof may be made by any of a variety of methods and/or of a variety of materials. In many instances, conventional cellular blind fabric may be the most convenient material for the window covering element, but paper or synthetic or other suitable materials may also form the window covering elements. Accordion-style coverings may be one form though other more rigid or flimsy alternatives may be available as well. Metal or other magnetized or magnetizable materials may form the track elements and the rod elements to create the magnetically active track(s). Shapes and sizes are not limited to those shown and described here either, as sizes and shapes may be selected to adapt to any of many alternative structures.

Historically, window coverings were a means to end, in that they would either block the outside world or let the outside world in, with little degree of control as to how much or how little they blocked. The present developments imparts a sense of freedom by allowing the user to choose a privacy level while simultaneously affording the user an opportunity to remain connected to the outside world. For example, if the user wants to sit inside a residence and read but not have to view passersby or nearby buildings, the present development may be adjusted to a suitable position so as to block those views yet still allow the user a view of the sky. Similarly, if the user wants some protection from the glare of the sun, but not complete window coverage, the blind may be adjusted to a different suitable position.

The present development may operate with a minimum of components. Installation is intended to be easy and to require minimal tools and time. The average consumer may be able to complete installation of one window blind in 30 minutes or less.

For example, the pre-installation of the present development may involve the steps of measuring one's windows, ordering the blinds on-line, and installing the blinds, with readily available tools such as a drill and a pair of scissors. The product may be offered in standard sizes corresponding to the most common window dimensions. Additionally, further customization of the product may be achieved, as the magnetically active tracks may be scored at regular intervals to allow a better fit in the window frame or may be adjustable so as to be extended or contracted to the desired size. The blinds may be made of a fabric that can easily be trimmed with a scissors if necessary. The packaging may include a fabric guide for a straight cut. Additional time savings may be realized in not having to adhere to an installer's schedule as the consumer can install the product when it is convenient for them.

Installation may be completed in similarly facile steps. First, the adjustable rods may be adjusted to the desired length to correspond to the dimensions of the window. Then, to install the product, the consumer may drill screws or put nails through pre-drilled apertures in the metal tracks to attach the metal tracks to the wall, window frame, or window reveal, or may activate the adhesive backing and adhere the tracks to the wall in the desired position. Next, the window covering element may be attached to the adjustable rods; for example, the adjustable rods may be inserted through the top and bottom of the window covering element, and adjusted to correspond to the dimensions of the window covering element. Then, the magnets may be attached to both ends of the rod. The rods may also have built-in magnets at either end; or the rods themselves may be magnetized. The rod may be slid down the track and the handle may be placed in the middle of the blind. The blind holder may be attached, and may take the form of an L-shaped piece where the shorter arm of the L may clip into the adjustable rod and the longer arm of the L may hold the lower part of the window covering element in place.

Thus provided is a window blind which may be one or more of cordless, easily positionable, durable, and easily installed window blind that may be placed in variety of positions to adapt to the user's particular needs for, e.g., privacy and sunlight blockage while remaining connected to the outside world.

Although the present developments have been described with reference to certain implementations, workers skilled in the art will recognize that changes may be made in form and detail without departing from the spirit and scope of the development described herein.

1. A window blind apparatus comprising a first magnetically active track, a second magnetically active track, a first rod, a second rod, a first magnet located at the first end of the first rod, and a second magnet located at the second end of the first rod, a third magnet located at the first end of the second rod, a fourth magnet located at the second end of the second rod, and a window covering material adapted to be disposed between the first rod and the second rod;
wherein the first and second rods are adapted to be disposed such that respective first and second ends are operatively engaged with the first and second tracks such that the first and third magnets are adapted to fixedly yet movably engage with the first and second tracks.

2. The window blind apparatus of claim 1, wherein the first magnetically active track and the second magnetically active track are adapted to be mounted on a surface in an orientation generally perpendicular to the ground.

3. The window blind apparatus of claim 1, wherein the first magnetically active track and the second magnetically active track are adapted to be mounted on opposite vertical sides of a window.

4. The window blind apparatus of claim 1, wherein the first magnetically active track and the second magnetically active track are adapted to be mounted on opposite vertical sides of the interior of a window reveal.

5. The window blind apparatus of claim 1, wherein a handle is mounted on at least one of the first and second rods.

6. The window blind apparatus of claim 1, wherein a blind holder is mounted on at least one of the first and second rods.

7. The window blind apparatus of claim 1, wherein the first magnetically active track and the second magnetically active track each have a ‘c’ shape defining a channel running longitudinally along each of the first magnetically active track and the second magnetically active track.

8. The window blind apparatus of claim 7, wherein the channel of the first magnetically active track is of a adapted to receive the first magnet element and the third magnet element, and the channel of the second magnetically active track is of a adapted to receive the second magnet element and the fourth magnet element.

9. The window blind apparatus of claim 1, further comprising one or more mounting apertures along the first magnetically active track and the second magnetically active track, wherein each mounting aperture is disposed to accept a mounting screw or screws for mounting the magnetically active track to the wall.

10. The window blind apparatus of claim 1, wherein the first magnetically active track and the second magnetically active track are adapted to be adhesively mounted to the wall.

11. The window blind apparatus of claim 1, wherein one or both of the first rod and the second rod are adjustable in length.

12. The window blind apparatus of claim 1, wherein one or both of the first track and the second track are adjustable in length.

13. A window blind apparatus as recited in claim 1, wherein the first magnetically active track and the second magnetically active track may be positioned at any distance in relation to each other limited only by the length of the first rod and second rod and the dimensions of the window structure.

14. A window blind apparatus as recited in claim 1, wherein the first rod is inserted through a first end of the window covering material and the second rod is inserted through the second end of the window covering material.

15. A window blind apparatus as recited in claim 1, wherein a soft friction-reducing covering is placed over the first magnet, second magnet, third magnet and fourth magnet.

16. A window blind apparatus as recited in claim 1, wherein the first and second rods are adapted to be disposed such that respective first and second ends are operatively engaged with the first and second tracks such that the first and third magnets are adapted to fixedly yet movably engage with the first and second tracks and the second and fourth magnets are adapted to fixedly yet movably engage with the first and second tracks.

17. A system for using a window blind apparatus, the system comprising:
a window blind apparatus having a first track element and a second track element, a window covering material, at least one adjustable rod, a first magnet located at the first end of the at least one rod, and a second magnet located at the second end of the at least one adjustable rod; wherein the first and second rods are adapted to be disposed such that respective first and second ends are operatively engaged with the first and second tracks such that the first and third magnets are adapted to fixedly yet movably engage with the first and second tracks
a window upon which the window blind apparatus is to be disposed.

18. A system according to claim 17, the system further comprising a second adjustable rod, a third magnet located at the first end of the second adjustable rod, and a fourth magnet located at the second end of the second adjustable rod; wherein the first and second rods are adapted to be disposed such that respective first and second ends are operatively engaged with the first and second tracks such that the first and third magnets are adapted to fixedly yet movably engage with the first and second tracks and the second and fourth magnets are also adapted to fixedly yet movably engage with the first and second tracks.

19. A method for providing readily-alterable coverings for a window, the method comprising:
mounting a first track element to a first portion of a wall and mounting a second track element to a second portion of the wall in a substantially parallel orientation to the first track element, wherein the first track element has a first channel and the second track element has a corresponding second channel;
attaching a first end of a window covering material to a first rod and a second end of the window covering material to a second rod;
placing the first rod between the first track element and the second track element, wherein the first rod has a first magnet on a first end of the first rod and a second magnet at the second end of the first rod, the first magnet of the first rod being adapted to be disposed within the channel of the first track element and the second magnet of the first rod being adapted to be disposed within the channel of the second track element; and
placing the second rod between the first track element and the second track element, in a substantially parallel orientation to the first rod, wherein the second rod has a third magnet at a first end of the second rod and a fourth magnet at the second end of the second rod, the third magnet of the second rod being adapted to be disposed within a channel of the first track element and the fourth magnet of the second rod being adapted to be disposed within a channel of the second track element.

20. The method of claim 19, further comprising positioning the first rod element and the second rod element at discrete points along the first track element and the second track element in such a manner as to achieve one of full extension of the window covering material and partial extension of the window covering material.

21-40. (canceled)
